(19) United States
(12) Patent Application Publication
(10) Pub. No.: US 2026/0183707 A1
(43) Pub. Date: Jul. 2, 2026

(54) Carbon Utilization and Storage through Rehabilitation of Groundwater Wells

(71) Applicant: Subsurface Technologies, Inc., Rock Tavern, NY (US)

(72) Inventors: Steven Catania, Gardiner, NY (US); Christopher Catania, Marco Island, FL (US); Patil Vivek, Salt Lake City, UT (US)

(73) Assignee: Subsurface Technologies, Inc., Rock Tavern, NY (US)

(21) Appl. No.: 19/129,119

(22) PCT Filed: Nov. 13, 2023
(86) PCT No.: PCT/US2023/079515

§ 371 Date: May 12, 2025

Related U.S. Application Data
(60) Provisional application No. 63/424,853, filed on Nov. 11, 2022.
(60) Provisional application No. 63/467,596, filed on May 18, 2023.

(51) Int. Cl. B01D 53/62; B65G 5/00; C09K 8/594; E03B 3/15

(52) U.S. Cl. CPC B01D 53/62; B65G 5/00; C09K 8/594; E03B 3/15; B01D 2257/504

(57) ABSTRACT

The present invention relates to a Carbon Capture Utilization and Storage (CCUS) opportunity through well rehabilitation. Aqua Freed® and Aqua Gard® are well-known well rehabilitation and preventive well maintenance technologies that utilize (inject into the subsurface in a methodical way) liquid CO₂ for the purpose. The object of this invention was to quantify the storage capacity of Aqua Freed® and Aqua Gard® and establish their CCUS credentials.

### FIELD OF THE INVENTION

The invention relates to the rise in carbon dioxide (CO₂) concentration in the atmosphere due to anthropogenic activities is considered as one of the primary drivers for climate change and a method to neutralize the carbon footprint.

### BACKGROUND OF THE INVENTION

Rise in carbon dioxide (CO₂) concentration in the atmosphere due to anthropogenic activities is considered as one of the primary drivers for climate change^{1,2}. The need to neutralize the carbon footprint and move towards ‘net-zero’ emissions is being widely recognized^{3,4}. The Intergovernmental Panel on Climate Change (IPCC) has reported that limiting global warming to 1.5° C. above the pre-industrial temperatures will require reaching net-zero emissions globally by 2050⁵. Most of the major corporations in the world have accordingly set their ‘net-zero’ goals, which means their own timeline to becoming carbon neutral^{6,7}. These ambitious goals can be achieved by (1) transitioning to low-carbon technologies and ‘green’ energy sources^{8,9}, and/or (2) carbon offsetting, which means removing a quantity of CO₂ equivalent to one's carbon footprint¹⁰.

One of the primary ways of carbon offsetting is by capturing CO₂, either from effluent industrial streams or directly from air, and keeping it away from the atmosphere by its reuse, recycle, storage and eventually sequestration¹¹. While there are several ways to achieve sequestration, both naturally and technologically (e.g., oceanic, rock weathering, mineralization, geologic, etc.), the most promising of these methods in terms of storage capacities, timescale and environmental impact is considered the geologic sequestration of CO₂¹².

Before storing it away, utilizing and recycling the CO₂ is often desirable and more feasible from a commercial standpoint¹³. Carbon Capture Utilization and Storage (CCUS) is a bracket term used to refer to any technological process that captures, utilizes, and stores the CO₂ away from the atmosphere¹⁴. The most widely known CCUS technology is CO₂-Enhanced Oil Recovery (CO₂-EOR), wherein CO₂ is injected into the subsurface to aid the tertiary recovery of crude oil that may be otherwise difficult to produce. Other known CCUS technologies include CO₂-Enhanced Geothermal Systems (using CO₂ as a working fluid instead of water) and CO₂-Enhanced Gas Recovery (using CO₂ to enhance natural gas recovery from the subsurface). All these technologies involve injecting CO₂ into the subsurface for a technological and commercial advantage. In the process, a portion of the CO₂ inadvertently remains in the subsurface.

In this invention, we introduce the use of CO₂ for rehabilitation and preventive maintenance of groundwater wells as another CCUS opportunity. All groundwater wells develop mineral and biological build-up over time, which results in a decline in the well's capacity to produce water (specific capacity) and the water quality. The traditional approach taken by well owners has been to rehabilitate a well when its specific capacity has dropped significantly. However, studies have shown that preventive maintenance scheduled on an annual basis helps increase the longevity of the well components, maintain better water quality, and reduce long-term operational costs¹⁵.

The benefits of using CO₂ on improving performance and aiding maintenance of wells have been recognized by the Oil & Gas sector. For example, Wilson and Bell¹⁶ have proposed a method of a combination of liquid CO₂, alcohol, and surfactants for cleaning up wellbore and near-wellbore areas of gas wells. In addition to well cleanup, CO₂ has also shown to provide benefits when used as a fracturing fluid for stimulation of low-permeability gas reservoirs¹⁷⁻¹⁹.

The technology of using CO₂ for groundwater well rehabilitation and maintenance has been established through the Aqua Freed® and Aqua Gard® processes^{20,21} that have been applied to groundwater well systems across the US and in some parts of Europe for over 35 years. Utilizing CO₂ for well rehabilitation has proven to be advantageous over other methods (e.g., traditional chemical and acid treatment, wire charge methods, fluid percussive methods, etc.) in terms of the well performance as well as the impact on water quality²². The goal of this study was to quantify the potential of carbon utilization and storage via CO₂-powered well rehabilitation technologies, using the example of Aqua Freed® (AF) and Aqua Gard® (AG), with field-collected data analysis and modeling. Using field measurements and statistical modeling approaches, we first estimate the percentage of injected CO₂ to get stored in the aquifer for a single well based on a data from a selected set of wells. We then apply these estimates to a larger database to estimate the total CO₂ that has been stored over the past decade through these technologies. Finally, we estimate the storage potential of this CCUS technology based on the US market size of private and public groundwater wells.

### BRIEF SUMMARY OF THE INVENTION

We introduce an attractive CCUS opportunity through well rehabilitation. Aqua Freed® and Aqua Gard® are well-known well rehabilitation and preventive well maintenance technologies that utilize (inject underground) liquid CO₂ for the purpose. The goal of this invention study was to quantify the storage capacity of Aqua Freed® and Aqua Gard®, and establish their CCUS credentials. Depending on the well being serviced, these technologies can inject up to 40 US tons of CO₂ per well. Based on field data collection and statistical modeling, it was estimated that 82-96 percent (median 90%) of the injected CO₂ remains in the subsurface post injection. Overall, our results and analysis of the US market suggest that using CO₂ for well rehabilitation and maintenance has a storage potential of several megatons of CO₂ annually in the US alone.

A method for CO2 utilization and storage in an aquifer is disclosed comprising using CO2 for well rehabilitation and preventive maintenance in improving well performance and efficiency and reducing the carbon footprint. The method comprising sealing a water well and injecting liquid and or gaseous CO₂ into the water well and unsealing the water well to allow the CO₂ to be stored in the water well aquifer formation.

The method further comprising modifying Aqua Freed or Aqua Gard technology to provide and enhance CO2 storage in the well aquifer.

The method increases penetration of CO2 in the well aquifer by controlling and maintaining a constant CO2 injection pressure to prevent back flow and upward movement of CO2/water mixture within the well.

The present process further comprises adjusting the CO2/water mixture to minimize expansion of CO2 in water allowing deeper CO2 aquifer penetration.

The present process still further comprising achieving additional CO2 storage by reducing a volume and rate of water flushing from the well after the completion of injecting CO2.

The present yet still further comprising allowing well pressure to dissipate naturally within the well aquifer by not allowing CO2 to escape from the well into ambient atmosphere.

### BRIEF DESCRIPTION OF THE FIGURES

FIGS. 1A, 1B, 1C, and 1D. Images of well screens captured during in-situ video inspections conducted before and after treating a well with CO₂.

FIGS. 2A and 2B. Observed CO₂ concentrations during flushing of 16 well events (dataset1)

FIG. 3. CO₂ concentration profile in mg/l or ppm along time during flushing for the 16 well events (dataset1).

FIG. 4. Plots showing the goodness of fit of the LME model to dataset1.

FIG. 5. Histogram of the estimated percentage CO₂ stored by individual wells for the total 31 well events (dataset1 and dataset2 combined).

FIGS. 6A and 6B. Statistical distribution (histogram) of the CO₂ utilized by STI's operations in 2021 based on individual wells. Left histogram represents AF treatments and right histogram represents AG treatments.

FIGS. 7A and 7B. Graphical depiction of the yearly distribution of number of wells serviced and estimated CO₂ injected by STI and its authorized providers.

FIGS. 8A and 8B. Histogram of the quantities of CO₂ injected in individual AF treatments done by STI from 2012-2021.

### DETAILED DESCRIPTION OF THE INVENTION

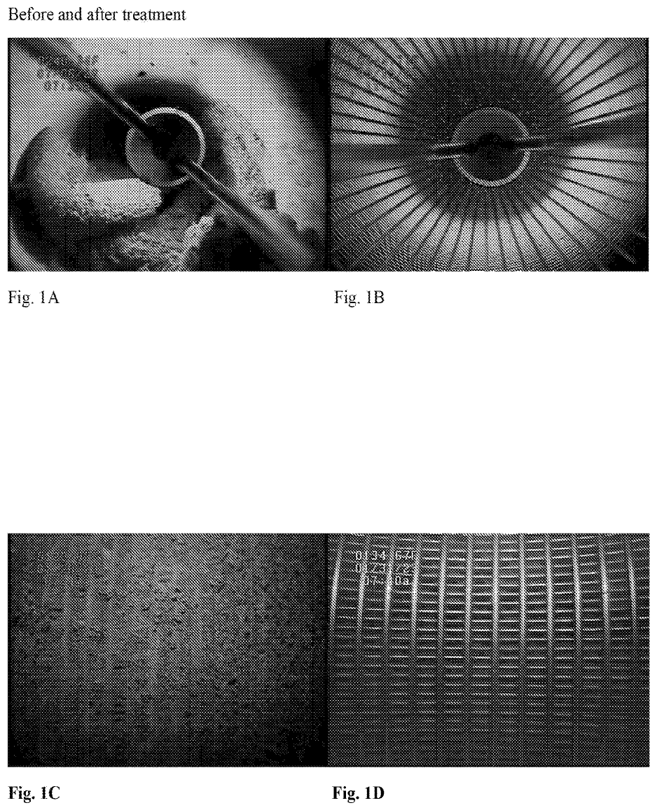

FIGS. 1A, 1B, 1C, and 1D present in-situ photographs of the inside of a groundwater well before and after its AF treatment. The photographs clearly demonstrate the extent of mineral, biological and iron incrustation build-up. CO₂-powered AF rehabilitation treatments have shown to increase a well's specific capacity by as much as 20 times²².

The quantity of CO₂ injected depends on the size of the well and how deep the well is. While the exact quantity for a particular well is based on a proprietary equation that considers well depth, well diameter, and borehole/screen length, the typical values are 2.5-5, 6-12 and 20-40 US Tons of CO₂ for small, medium, and large-sized wells respectively.

Both AF and AG follow the same above process. The main difference between the two is that AG, being a preventive care program for a well that is a follow up after AF treatment, requires a smaller quantity of CO₂ as compared to AF (typically about one-fifth) for the same well.

FIGS. 1A, 1B, 1C, and 1D are images of well screens captured during in-situ video inspections conducted before and after treating a well with CO₂.

### Approach to Estimating Storage Potential

Since the quantity of injected CO₂ is known for a well, the foremost way to quantify how much of it got stored is by estimating the loss of CO₂ at each of the steps of the AF/AG process described above. Subtracting the total loss of CO₂ throughout the process from the injected quantity directly leads us to how much CO₂ remained in the subsurface after the process was completed and the well was handed back to the owner.

An up-close examination of the process led to the conclusion that any losses of CO₂ would happen at the venting, flushing and post-injection pump test. Usually, the post-injection pump test is directly followed by flushing. Therefore, the loss during the post-injection pump can be combined with the loss during flushing. Thus, the mass balance equation of CO₂ for the AF/AG process is CO₂ stored □ CO₂ injected —{CO₂ loss during venting □ CO₂ loss during flushing}.

### Results

### Loss Estimation

### Venting

Data during the venting process was collected using a flow meter at 2 independent wells undergoing AG treatment. The venting time for the first well was 1 minute at a flowrate of 100 ft³□min for first 30 seconds and 25 ft³□min for the remaining 30 seconds. Converting the volume of CO₂ to mass assuming CO₂ density of 1.87 kg/m³ (at ˜15° C. and 1 atm), the mass of CO₂ lost during venting was estimated to be 7.2 lbs. Given the mass of CO₂ at this well was 2000 lbs., the percentage of CO₂ lost during venting was estimated to be 0.36%. Following the same procedure, the percentage of CO₂ lost during venting at the second well was estimated to be 0.39%. The timing of the venting at other wells was observed to be in the similar range. Therefore, it was assumed that the loss of venting is expected to be less than 1% in all cases and can be ignored in the storage estimations.

### Flushing (Including Post-Treatment Pump Test)

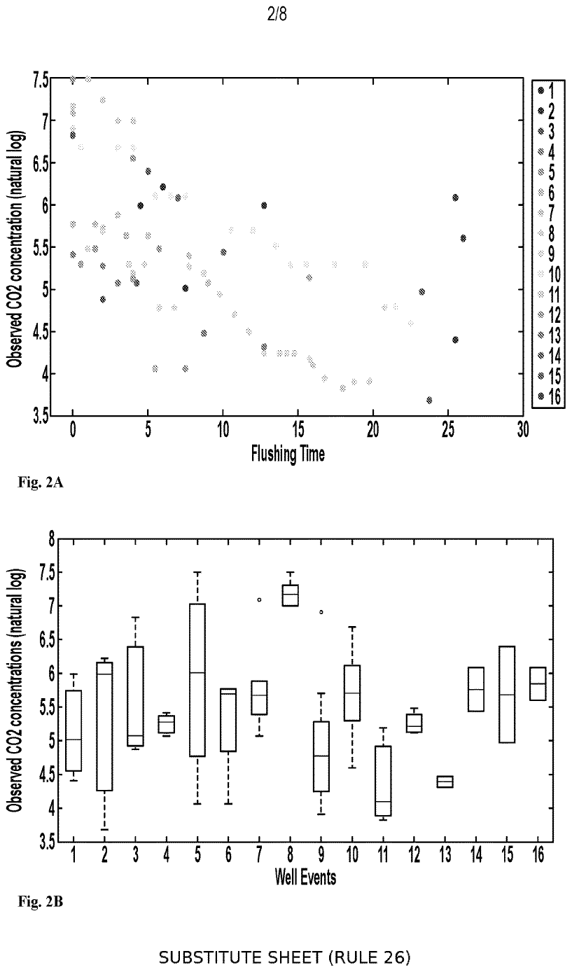

As part of this invention study, CO₂ concentrations and pumping rates were noted during flushing at 16 wells being processed with AF/AG (referred to as dataset1). In addition, historic data for 15 additional wells was retrieved from STI's records with pumping rate data but no available measurements of concentration (referred to as dataset2). Dataset1 (with 2 or more concentration data points for each well) was used to model the trend of concentration drop a long time. A visual inspection of the concentration vs. time plots indicated an exponential trend in most of the wells. Therefore, a natural log of these values would follow a linear trend. The distribution of concentration data collected during flushing of 16 well events (dataset1) is presented in FIGS. 2A and 2B.

FIGS. 2A and 2B are observed CO₂ concentrations during flushing of 16 well events (dataset1).

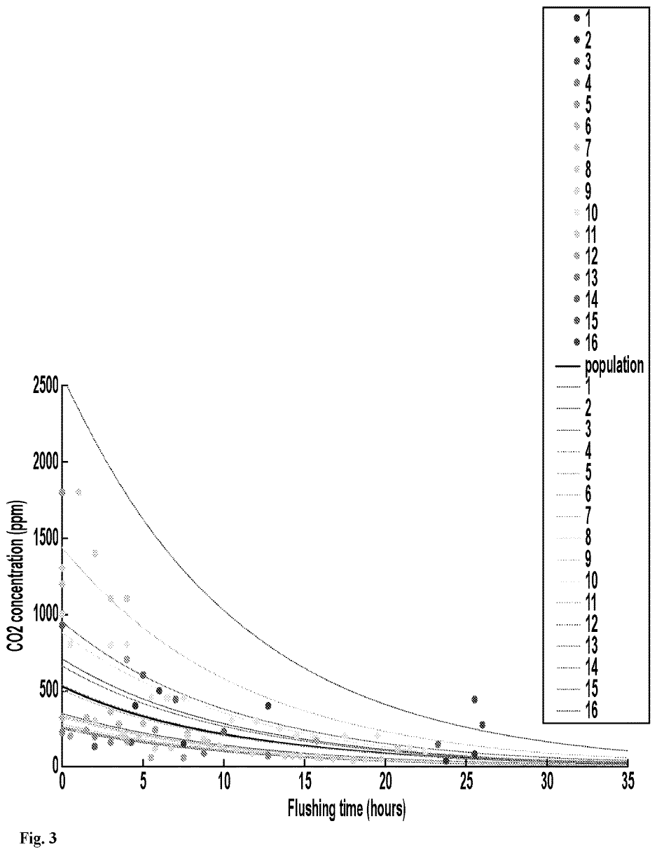

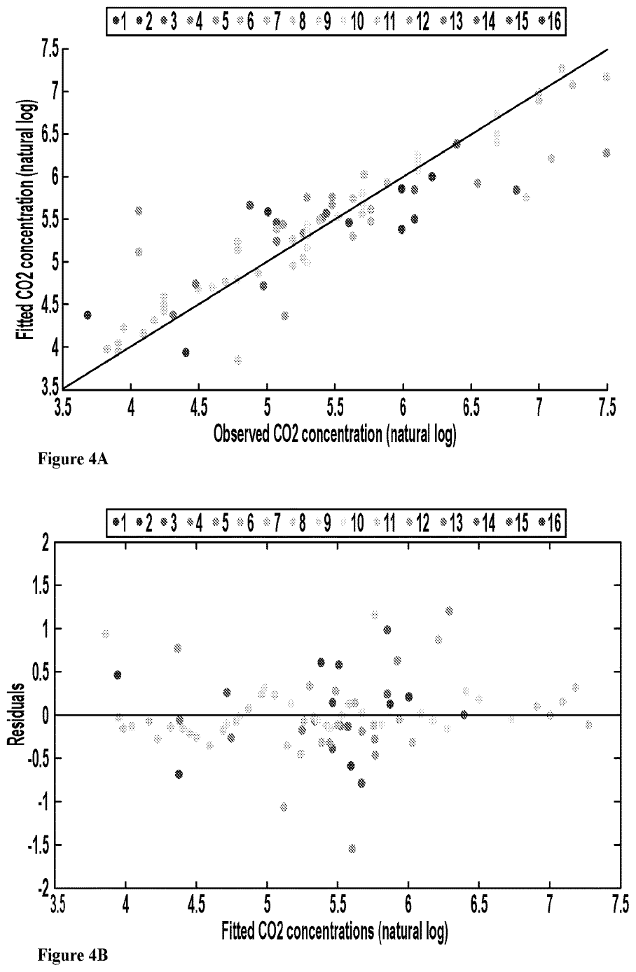

To determine a general trend and rate of concentration drop during the flushing process, a linear mixed-effects (LME) regression²³ approach was chosen. This approach is a widely used for multilevel or hierarchical modeling, wherein both the population wide trend as well as trends at the level of subgroups are important^{24,25}. In our case, the LME model takes into account both individual well trends (called ‘random’ effects) as well as a population-wide trend (called ‘fixed’ effect). Detailed discussion on model selection and cross-validation is featured in the Methods section and supplementary information. The relevant statistics of the LME regression model fitted to dataset1 are presented in Table 1. FIG. 3 presents the resulting regression fits for the individual wells (random) and the population fit (fixed) converted back from natural log values to real values of concentration. The goodness of this fit is graphically presented in FIG. 4. The fitted vs. observed values plot shows that the points align uniformly along the diagonal (y=x), which signifies that model predictions compare closely with observed data. The residual plot shows that the points are scattered randomly around the residual=0 line with no particular pattern, which indicates the LME model is the correct choice for this dataset.

TABLE 1
The results of the Linear Mixed-Effects (LME) model
fitting to the CO₂ concentration trends during
flushing for 16 individual wells (dataset1).

| | | | | Random effects | |
|---|---|---|---|---|---|
| Fixed effects (population) | | | | (individual wells) | |
| | Estimate | | | | Std. Dev. |
| | (Std. | | | | (Lower, |
| Parameter | Error) | P-value | 95% CI | Parameter | Upper) |
| Intercept | 6.271 | 1.75E−46 | 5.87 | Intercept | 0.694 |
| | (0.201) | | to 6.672 | PDF | (0.457, |
| | | | | | 1.05) |
| Slope | −0.092 | 5.21E−16 | −0.11 | Slope PDF | Does not |
| | (0.009) | | to −0.074 | | vary |

Using the individual concentration trends for dataset1, the population concentration trend for dataset2, and known volumetric flowrates during flushing for these wells, the mass of CO₂ lost incrementally along time is simply calculated as a mathematical product of concentration (mass per volume), flowrate (volume per time) and flushing time. This yields us the total mass of CO₂ lost during flushing, which when compared to the mass of CO₂ injected leads to the effective percentage of CO₂ stored in the subsurface for that well. The estimated percent of CO₂ stored for each of the total 31 wells from dataset1 and dataset2 are presented in Table 2.

### Storage Estimation

### Storage Estimates Per Well

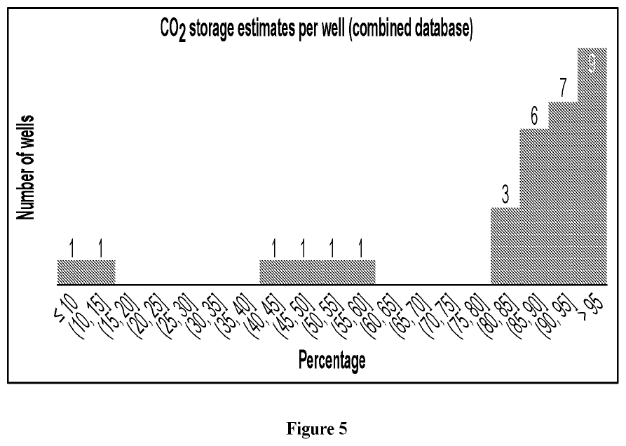

The general statistical distribution across the entire database of well events is presented in FIG. 5 and Table 3. Based on the combined set of 31 wells, the median estimated proportion of CO₂ that remains or is stored in the subsurface after any AF or AG process is about 90% and the interquartile range is between 82% to 96%. This means that at least three-fourth of all the groundwater well treatments with CO₂ via the AF/AG processes will store more than ˜82 percent (typically ˜90%) of the injected mass of CO₂ underground after the treatment process is complete.

FIG. 3. CO₂ concentration profile in mg/l or ppm along time during flushing for the 16 well events (dataset1). The color-coded circles represent actual data points for each well and color-coded lines represent the regression fits to these data points using the LME model (converted from natural log to real values). The thicker black line represents the ‘fixed’ effect or the population trend, while the colored dash lines represent the ‘random’ effects or the individual well trends.

### Storage Estimates for the Year 2021

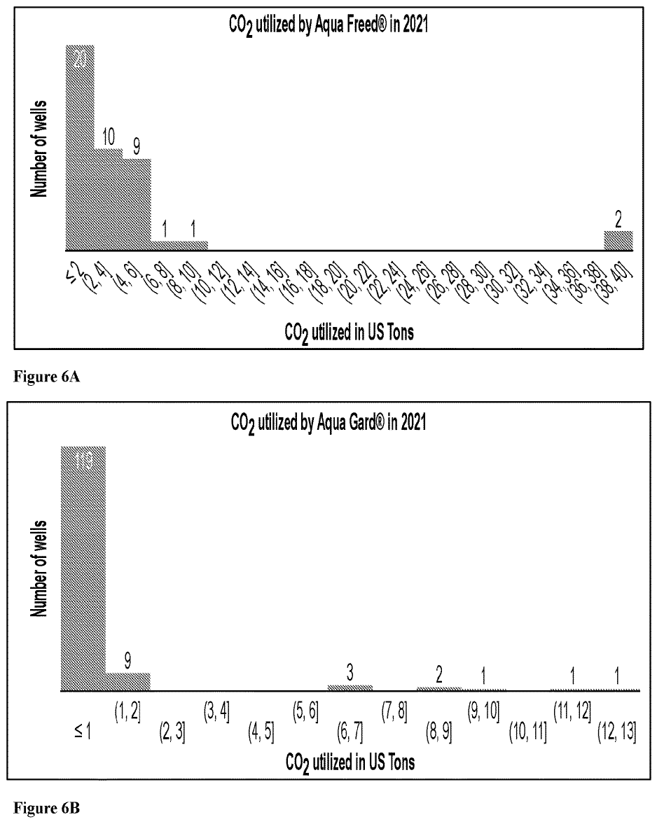

The total quantity of CO₂ utilized (injected into the subsurface) by the well rehabilitation and maintenance services completed by STI in the year 2021 was 700,600 pounds or 350.3 US Tons. The statistical distribution based on individual wells serviced in 2021 for AF and AG treatments is shown in FIG. 6. Based on the interquartile range of the percent storage for individual wells calculated above, the estimated mass of CO₂ stored by STI's operations in 2021 is 287 to 336 US tons. These estimates represent STI's operations only and are not inclusive of any CO₂-powered well treatments conducted by the authorized providers of STI.

### Storage Estimates for the Decade 2012-21

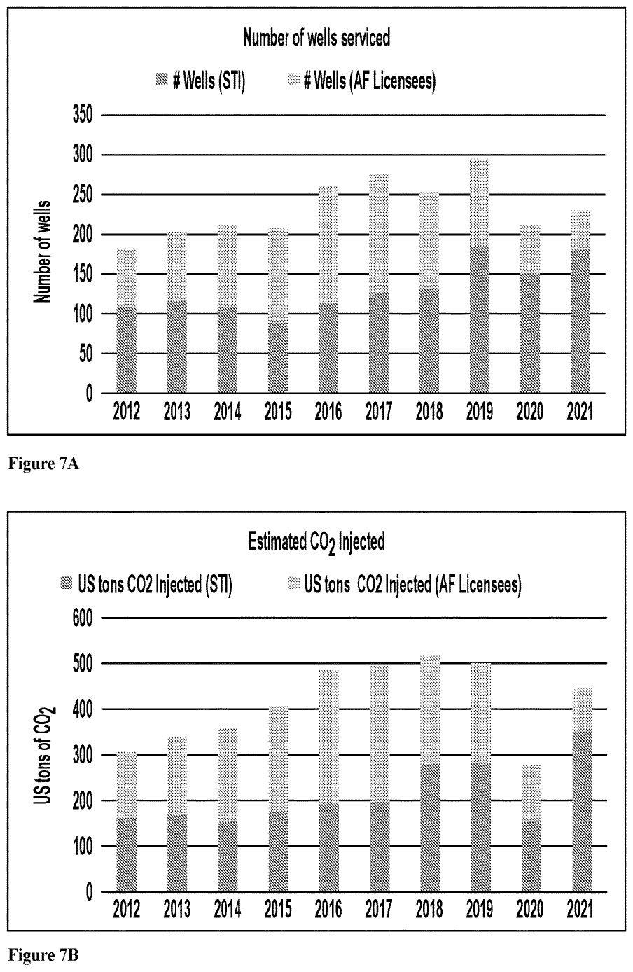

The total estimated CO₂ utilized by CO₂-powered well rehabilitation and maintenance treatments (AF and AG) in the past decade (2012-2021) was estimated by accounting for all the wells serviced directly by STI as well their authorized providers (licensees). To the best of our knowledge, there are no other entities operating such technologies for the purpose of rehabilitating groundwater wells. A yearly breakdown of the number of wells serviced and the tonnage of CO₂ utilized is presented in Table 4 and graphically represented in FIG. 7.

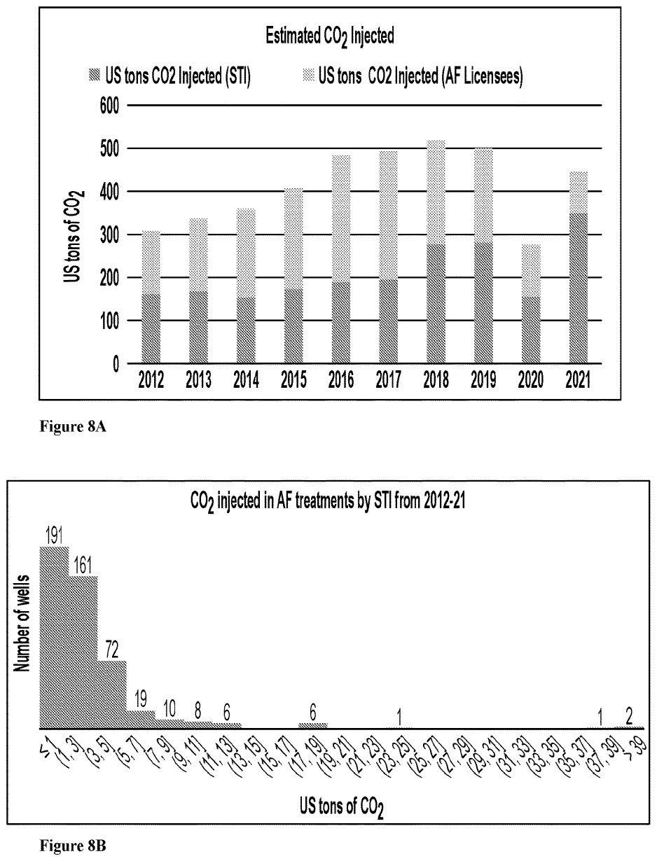

While the exact quantity of CO₂ injected at each well by STI in the past decade was known, there was no information on that for the AF authorized providers except the number of wells serviced. However, we can assume that the median and interquartile range of the CO₂ injection quantities for AF licensees would be similar to that of the AF treatments done by STI directly. FIG. 8 shows the statistical distribution of the CO₂ quantity utilized in 477 AF treatments done by STI in the past decade. The median value of the distribution was 2 tons, with the interquartile range from 0.65 to 3.5 tons of CO₂. The estimated tonnage of CO₂ utilized by AF authorized providers in Table 4 was calculated based on the median value of 2 tons. The total range of CO₂ tonnage (based on the interquartile range of 0.65 to 3.5 tons) was estimated to be 2761 to 5668 tons of CO₂. Thus, assuming a median 90% of storage, the cumulative estimated CO₂ stored by STI and its authorized providers together over the past decade (2012-2021) is 2485 to 5101 US tons (median value of 3724 US tons).

### Future Projections

According to the National Ground Water Association (NGWA), there are a total of about 16 million water wells in the U.S.²⁶ About 13 million of these wells are residential, while the rest are non-residential (industrial, public water supply, agricultural, etc.). Based on STI's experience, residential wells are typically small wells that generally require about 1000 lbs. of CO₂ for AF treatment. Non-residential wells can be divided into three categories, small, medium and large, based on their size and capacity.

FIGS. 4A and 4B are plots showing the goodness of fit of the LME model to dataset1.

FIG. 5. is a histogram of the estimated percentage CO₂ stored by individual wells for the total 31 well events (dataset1 and dataset2 combined).

The quantity of CO₂ required for AF treatments is 2.5-5 tons, 6-12 tons and 20-40 tons for small, medium and large water wells respectively. Subsequent AG treatments for annual maintenance typically require about one fifth of that.

Based on the CO₂ requirements and STI's database of processed wells from the past decade (see FIG. 8), the ratio of small, medium and large wells is 89%, 8%, and 3%. This ratio is likely to be a conservative ratio, as this includes both residential (which are usually smaller in size and larger in number) and non-residential wells. However, due to lack of information, we assume the same ratio applies to non-residential wells across the U.S.

Based on the number of wells in the U.S. and the typical amount of CO₂ required for rehabilitation and annual maintenance, we estimate (as shown in Table 5) that adopting CO₂-powered well rehabilitation and maintenance techniques have the potential of utilization and storage of about 20 million US tons of CO₂ every 15 years (average rehabilitation cycle for a water well). Annual maintenance programs like AG can help store an additional 4 million US tons on an annual basis. These are the estimates of the utilization potential based on a single country.

### Discussion

Storage vs. sequestration It is important to note that the terms storage and sequestration are often used interchangeably, but there is a subtle difference between them. Storage is a broad term, of which sequestration can be considered a subset that usually refers to long-term, ‘permanent’ storage (typically hundreds to a thousand years in the future)^{27,28}. The focus of this study was on the quantifying CO₂ storage (what remained in the subsurface after the process was completed and the well was handed back to the owner). Investigating long-term fate and migration of the injected CO₂ is a more complex scope of study and will require multiphase geochemically reactive transport modeling of site-specific case studies (similar examples of which can be found in the literature)²⁹⁻³¹. Studies following this will aim at tackling these research directions. Long-term fate of injected CO₂ Typically, once CO₂ is injected, it remains in the subsurface as either a separate gas/supercritical phase, dissolved aqueous phase or precipitated mineral phase.

Table 2. A database of 31 AF/AG events used for calculating the loss of CO₂ during flushing along with the estimated percentage of CO₂ stored during each event is presented in this table. The first 16 well events (rows marked with ‘yellow’ color), considered as dataset1, were conducted as part of this study and CO₂ concentration measurements along time were available along with flowrate information. The next 15 well events (rows marked with ‘blue’ color) were retrieved from STI's records prior to this study and only flowrate information was available for these events.

The common modes of CO₂ trapping in the subsurface are stratigraphic or structural gas trapping (being trapped as a gas phase between strategic geologic features like faults, seals, caprocks etc.)^{32,33}, residual gas trapping (residual irremovable gas being trapped in fine pores by capillary forces)^{34,35}, dissolution trapping (being trapped in solution as bicarbonate)^{36,37}, and mineral trapping (being converted to a carbonate mineral phase)^{38,39}. The relative proportion of CO₂ stored via each of these individual mechanisms will depend on the exact, site-specific hydrogeological conditions. For the present application, because of relatively low quantities of CO₂ being injected compared to CO₂-EOR or deep saline sequestration, it can be expected that the structural gas trapping capacity will be relatively low. Almost all of the stored CO₂ will get converted to aqueous CO₂ relatively instantaneously. Geochemical buffering of the elevated acidity from this solubility trapping by in-situ water rock reactions will consume the dissolved CO₂ and may convert some of it to secondary precipitated minerals. Initially, when the fluid pressures are high, especially near the well, CO₂ will dissolve in water forming bicarbonate. As pressures reduce, the bicarbonate may convert back to gaseous CO₂, especially at near-surface depths⁴⁰. Therefore, we anticipate more sequestration in deeper wells or aquifers that are confined by a seal layer as compared to shallow unconfined formations. Depending on the mineralogy of the aquifer, near-well regions may go through dissolution of minerals (especially carbonates), generating wormholes⁴¹ or enhancing preferential flow pathways like faults and fractures⁴². On the other hand, some of the dissolved CO₂ may precipitate as carbonates in faults and fractures, in deeper subsurface^{43,44} as is evidenced in many outcrops^{45,46}. Some of the gaseous CO₂ may enter into the vadose zone and the soil. Depending on the level of vegetation in the area, some of the CO₂ may get consumed by plants. Thus, the net proportion of sequestration from the initially stored CO₂ quantity will differ from site to site. A few case studies conducted under varying hydrogeological conditions should help draw some generally 6.

TABLE 3
Statistics of the estimated percentage of CO₂ stored from
the dataset of individual wells. Across the entire set of
31 wells, the median storage estimation is ~90% with the
interquartile range from ~82% to 96%.
Estimated % CO₂ stored

| | Dataset | | |
|---|---|---|---|
| | 1 | 2 | Combined |
| # Wells Events | 16 | 15 | 31 |
| Q0 (min) | 10.3 | 9.3 | 9.3 |
| Q1 (25th) | 81.8 | 84.5 | 82.4 |
| Q2 (median) | 88.1 | 90.5 | 90.2 |
| Q3 (75th) | 94.4 | 95.5 | 95.5 |
| Q4 (max) | 99.1 | 97.8 | 99.1 |

FIGS. 6A and 6B. Statistical distribution (histogram) of the CO₂ utilized by STI's operations in 2021 based on individual wells. Left histogram represents AF treatments and right histogram represents AG treatments.
Impact on groundwater quality. Undisturbed naturally occurring groundwater can be usually found in chemical equilibrium with the solid phase (rock minerals) of the aquifer. However, when CO₂ is added to the aquifer, it dissolves in the groundwater leading to decreased pH (increased acidity) of the water, and thus disturbing the geochemical equilibrium. The subsequent geochemical reactions that get triggered between this acidified groundwater and the aquifer minerals (referred to as buffering) have the potential mobilize certain trace metals (including lead and arsenic). Studies have found that the concentrations of these mobilized trace metals do not reach up to or exceed the maximum permitted levels, except in rare cases where the aquifer is naturally rich in these minerals and already has elevated concentrations in the groundwater⁴⁷⁻⁴⁹.
Use of recycled CO₂. In order to create a greater impact on climate change, it is crucial to obtain the injected CO₂ which is ‘captured’ from anthropogenic sources (such as coal-fired powerplants or other industries). CO₂ capturing technologies has been around for a few decades, but the economic challenges (high cost) have been at the forefront in inhibited the wide commercial implementation of these techniques⁵⁰. However, the global push towards becoming carbon neutral has driven significant research and development of these technologies, including a few commercial-scale initiatives that are in the early stages⁵¹. Direct Air Capture of CO₂ is yet another challenging but critical field of upcoming technologies that work on capturing CO₂ directly from the atmosphere instead of a point source like a chemical plant. Utilization of recycled CO₂ is critical to achieving net-zero, and techno-economically efficient CO₂ capture methods are the first step in the direction.

### CONCLUSION

An analysis and review of the CO₂ utilization and storage potential of the Aqua Freed® and Aqua Gard® technologies demonstrates the benefit of using CO₂ for well rehabilitation and preventive maintenance in improving well performance and efficiency and reducing the carbon footprint. Thus, injecting CO₂ into the subsurface for well rehabilitation is yet another proven method for achieving CCUS and moving towards net-zero emissions. Typically, about 90% of the injected CO₂ is estimated to remain in the subsurface. CO₂-powered well rehabilitation if adopted widely as a CCUS technology has the capacity to store several megatons of CO₂ annually.

TABLE 4
A yearly distribution of CO₂-powered well rehabilitation
and maintenance activities for the past decade (2012-2021).
An estimated 4100 tons of CO₂ was utilized (injected
into the subsurface).

| | | | | US tons CO₂ | US tons CO₂ |
|---|---|---|---|---|---|
| | # Wells | # Wells (AF | # Wells | Injected | Injected |
| Year | (STI) | Licensees) | (total) | (STI) | (AF Licensees) |
| 2012 | 109 | 74 | 183 | 160.1 | 148 |
| 2013 | 117 | 86 | 203 | 167.3 | 172 |
| 2014 | 109 | 103 | 212 | 153.6 | 206 |
| 2015 | 90 | 118 | 208 | 171.2 | 236 |
| 2016 | 114 | 147 | 261 | 191.0 | 294 |
| 2017 | 127 | 150 | 277 | 194.6 | 300 |
| 2018 | 133 | 121 | 254 | 277.3 | 242 |
| 2019 | 184 | 111 | 295 | 278.8 | 222 |
| 2020 | 151 | 62 | 213 | 153.6 | 124 |
| 2021 | 182 | 48 | 230 | 350.3 | 96 |
| Total | 1316 | 1020 | 2336 | 2097.6 | 2040 |

FIGS. 7A and 7B are graphical depiction of the yearly distribution of number of wells serviced and estimated CO₂ injected by STI and its authorized providers.

### Methods

### Field Data Collection

The loss during venting was estimated by placing a flowmeter at the vent and timing the venting process. For estimating the loss during flushing, the concentration of CO₂ was measured along time in the field as the groundwater was being flushed out during AF/AG treatment of 12 different wells processed during the course of this study. The procedural steps of measuring CO₂ concentrations in the field are as follows:
Measure 100 ml of water in a graduated cylinder and transfer to flask.
Pour in 1 packet of phenolphthalein indicator powder and let it dissolve.
Use handheld, digital titrator equipped with a cartridge of 3.636 N.
Swirl in drops of sodium hydroxide until the water turns a light hue of pink.

FIGS. 8A and 8B are histogram of the quantities of CO₂ injected in individual AF treatments done by STI from 2012-2021.

TABLE 5
Estimating the national capacity of CCUS through rehabilitation and maintenance of water wells

| Non-residential | Residential | Small | Medium | Large | Total |
|---|---|---|---|---|---|
| No. of water wells in the US | 13,000,000 | 2,666,667 | 232,704 | 100,629 | 16,000,000 |
| CO₂ injected per well via AF (lb) | 1000 | 7500 | 18000 | 60000 | |
| Total CO₂ injected via AF (million US Tons) | 6.5 | 10 | 2.1 | 3 | 21.6 |
| Estimated CO₂ stored via AF (million US | 5.9 | 9 | 1.9 | 2.7 | 19.5 |
| Tons) | | | | | |
| Annual CO₂ stored via AG (million US Tons) | 1.2 | 1.8 | 0.4 | 0.5 | 3.9 |

Take the number read on the digital titrator and multiply it by a suitable multiplier depending on the amount of water measured and the range desired.

In addition to the CO₂ concentrations, the discharge rate at which the well was flushed was also noted.

### Statistical Data Modeling

We use a linear mixed-effects regression approach to model the CO₂ concentration trends during the flushing phase of an AF/AG well event. A Linear mixed-effects (LME) model is an extension of the simple linear regression (SLR) model²³. It has been found useful to adopt the LME approach when the collected data can be segregated into meaningful subgroups, and is widely applied to biological, social and healthcare research²⁴. In the case of this study, the subgroups are the individual well data. The LME model jointly estimates well-specific regression coefficients along with the population-level regression coefficients. Thus, we derive the overall trend (across all well events) as well as well-specific trends (Table 1).

It is important to note that the LME approach is very different from estimating well-specific trends individually, and then separately estimating the overall trend. The LME model estimates the ‘distribution’ of well-specific random effects around the population-level fixed effects. Thus, the fixed effect parameters (slope and intercept) estimated by LME may differ from the slope and intercept values that a SLR model would yield.

Some of the advantages of using LME over SLR for data that can be summarized groupwise are as follows:
LME uses the data much more efficiently making it better scalable to larger number of wells.
Due to the above feature, it works well with unbalanced and smaller data sets (by avoiding convergence issues) and can utilize and accommodate missing observations (e.g., concentration measurements missing at certain time points.)
LME jointly estimates population and subject-specific values and therefore is the more accurate (and interpretable) representation of repeated-measures data. It naturally takes into account the correlation between repeated scans from subjects. This is why it naturally prevents overfitting.

Since the concentration data of well events from dataset1 is exponential, natural logarithmic values of the concentration were used for our regression modeling, which is linear. Four regression models (3 different combinations of the LME and 1 SLR for comparison) were tested and cross-validated to find the one that best represents of the data.

Model choices:
1. LME: Both slope and intercept vary for both fixed and random effects
2. LME: Both slope and intercept vary for both fixed effects; only intercept varies for random effects
3. LME: Both slope and intercept vary for both fixed effects; only slope varies for random effects
4. SLR: Simple linear regression applied to concentration data of all well events from dataset1 combined (for comparison with LME)

Cross-validation is one of the most popular statistical techniques that is widely used model validation^{52,53}. Essentially, cross-validation tells us how well would the selected model generalize to ‘unseen’ data. Details and results of model selection and cross-validation are provided in supplementary information. Model 2 was found to have the least ‘test’ error (meaning it generalizes the data best) and was selected for further analysis in the Results section.

All modeling was performed using the MATLAB software⁵⁴. The code for this study is based on original code developed by Sharma (cite github). Table 2. A database of 31 AF/AG events used for calculating the loss of CO₂ during flushing along with the estimated percentage of CO₂ stored during each event is presented in this table. The first 16 well events (rows marked with ‘yellow’ color), considered as dataset1, were conducted as part of this study and CO₂ concentration measurements along time were available along with flowrate information. The next 15 well events (rows marked with ‘blue’ color) were retrieved from STI's records prior to this study and only flowrate information was available for these events.

Some wells are taken out of service due to declining water levels, sand production, poor water quality and contamination. Out of service water wells can be used for carbon storage. This includes water supply wells, environmental recovery and remediation wells, injection wells and ASR wells. Using this technology in wells that are out of service does not require venting, flushing, or purging which will lead to nearly 100% storage of the injected CO₂.

### REFERENCES

1. Kellogg, W. W. Climate change and society: consequences of increasing atmospheric carbon dioxide (Routledge, 2019).
2. Solomon, S., Plattner, G.-K., Knutti, R. & Friedlingstein, P. Irreversible climate change due to carbon dioxide emissions. Proc. national academy sciences 106, 1704-1709 (2009).
3. Davis, S. J. et al. Net-zero emissions energy systems. Science 360, eaas9793 (2018).
4. Bouckaert, S. et al. Net zero by 2050: A roadmap for the global energy sector. Tech. Rep., International Energy Agency (2021).
5. Masson-Delmotte, V. et al. Global warming of 1.5 c. An IPCC Special Rep. on impacts global warming 1, 43-50 (2018).
6. Allen, M. R. et al. Net zero: science, origins, and implications. Annu. Rev. Environ. Resour. 47, 849-887 (2022).
7. Lin, A. C. Making net zero matter. Wash. & Lee L. Rev. 79, 679 (2022).
8. Malhotra, A. & Schmidt, T. S. Accelerating low-carbon innovation. Joule 4, 2259-2267 (2020).
9. Kovac ̆, A., Paranos, M. & Marcius̆, D. Hydrogen in energy transition: A review. Int. J. Hydrog. Energy 46, 10016-10035 (2021).
10. Broekhoff, D., Gillenwater, M., Colbert-Sangree, T. & Cage, P. Securing climate benefit: A guide to using carbon offsets. Stock. Environ Inst Greenh Gas Manag. Inst 60 (2019).
11. Zhang, Z. et al. Advances in carbon capture, utilization and storage (2020).
12. Raza, A., Gholami, R., Rezaee, R., Rasouli, V. & Rabiei, M. Significant aspects of carbon capture and storage—a review. Petroleum 5, 335-340 (2019).
13. Nocito, F. & Dibenedetto, A. Atmospheric CO₂ mitigation technologies: carbon capture utilization and storage. Curr. Opin. Green Sustain. Chem. 21, 34-43 (2020).
14. Zhang, Z. et al. Recent advances in carbon dioxide utilization. Renew. sustainable energy reviews, 125, 109799 (2020).
15. Mansuey, N. & Miller, G. P. Treatment approach to reduce well maintenance costs. Ultrapure Water (2007).
16. Wilson, D. R. & Bell Jr, T. A. Liquid carbon dioxide cleaning of wellbores and near-wellbore areas (2006). U.S. Pat. No. 6,988,552.
17. King, S. Liquid CO₂ for the stimulation of low-permeability reservoirs. In SPE/DOE Low Permeability Gas Reservoirs Symposium (OnePetro, 1983).
18. Gromakovskii, D., Palanivel, M., Lopez, A. & Mikaelyan, V. Efficient CO₂ multistage acid stimulation in deep hot-gas reservoirs. In SPE Middle East Oil and Gas Show and Conference (OnePetro, 2019).
19. Al-Dhamen, M. & Soriano, E. Increased well productivity from the use of carbon dioxide to foam fracturing fluids during a refracturing treatment in saudi arabia. In SPE Latin American and Caribbean Petroleum Engineering Conference (OnePetro, 2015).
20. Catania, S. M. & Catania, C. L. Method for stimulation of liquid flow in a well (1995). U.S. Pat. No. 5,394,942.
21. Mansuy, N., Catania, S. & Orlando, J. Method of water well rehabilitation (2022). U.S. Pat. No. 11,225,853. Aqua Freed® and Aqua Gard® Case Studies. https://www.subsurfacetech.com/aqua-freed-case-studies/. Accessed: 2023 Jan. 2.
22. Pinheiro, J. C. & Bates, D. M. Linear mixed-effects models: basic concepts and examples. Mix. models S S-Plus 3-56 (2000).
23. Sharma, A. & DiBella, E. Longitudinal modeling of stroke using stochastic distances and noddi diffusion model. In Proceedings of the 2023 ISMRM & ISMRT Annual Meeting (ISMRM, 2023).
24. The MathWorks Inc. Linear mixed-effects models. https://www.mathworks.com/help/stats/linear-mixed-effects-models.html (2022).
25. Groundwater fundamentals. https://www.ngwa.org/what-is-groundwater/About-groundwater (2022). Accessed on Feb. 22, 2023.
26. McPherson, B. & Cole, B. Multiphase CO₂ flow, transport and sequestration in the powder river basin, Wyoming, USA. J. Geochem. Explor. 69, 65-69 (2000).
27. Patil, V. V., McPherson, B. J., Priewisch, A., Moore, J. & Moodie, N. Factors affecting self-sealing of geological faults due to CO₂-leakage. Greenh. Gases: Sci. Technol. 7, 273-294 (2017).
28. Audigane, P., Gaus, I., Czernichowski-Lauriol, I., Pruess, K. & Xu, T. Two-dimensional reactive transport modeling of CO₂ injection in a saline aquifer at the sleipner site, North Sea. Am. journal science 307, 974-1008 (2007).
29. Xu, T., Kharaka, Y. K., Doughty, C., Freifeld, B. M. & Daley, T. M. Reactive transport modeling to study changes in water chemistry induced by CO₂ injection at the frio-i brine pilot. Chem. Geol. 271, 153-164 (2010).
30. Patil, V. & McPherson, B. J. Modeling coupled reactive transport through fault zones: A critical review. Environ. Eng. Sci. 38, 165-180 (2021).
31. Iglauer, S. Optimum storage depths for structural CO₂ trapping. Int. J. Greenh. Gas Control. 77, 82-87 (2018).
32. Szulczewski, M., Hesse, M. & Juanes, R. Carbon dioxide dissolution in structural and stratigraphic traps. J. Fluid Mech. 736, 287-315 (2013).
33. Burnside, N. & Naylor, M. Review and implications of relative permeability of CO₂/brine systems and residual trapping of CO₂. Int. J. greenhouse gas control 23, 1-11 (2014).
34. Raza, A. et al. Assessment of CO₂ residual trapping in depleted reservoirs used for geosequestration. J. Nat. Gas Sci. Eng. 43, 137-155 (2017).
35. Gilfillan, S. M. et al. Solubility trapping in formation water as dominant CO₂ sink in natural gas fields. Nature 458, 614-618 (2009).
36. Gasda, S., Nordbotten, J. & Celia, M. Vertically averaged approaches for CO₂ migration with solubility trapping. Water Resour. Res. 47 (2011).
37. Bachu, S., Gunter, W. & Perkins, E. Aquifer disposal of CO₂: hydrodynamic and mineral trapping. Energy Convers. management 35, 269-279 (1994).
38. Xu, T., Apps, J. A. & Pruess, K. Numerical simulation of CO₂ disposal by mineral trapping in deep aquifers. Appl. geochemistry 19, 917-936 (2004).
39. Patil, V. V. Self-sealing of faults in geological carbon sequestration. Ph.D. thesis, The University of Utah (2016).
40. Xiao, T., Kweon, H., McPherson, B. & Deo, M. Wormhole generations in Indiana limestone with CO₂ intrusion: Numerical simulations based on core flooding experiments. Energy & Fuels 31, 12487-12499 (2017).
41. Brunet, J.-P. L., Li, L., Karpyn, Z. T. & Huerta, N. J. Fracture opening or self-sealing: Critical residence time as a unifying parameter for cement-CO₂-brine interactions. Int. J. Greenh. Gas Control. 47, 25-37 (2016).
42. Tian, H. et al. A numerical study of mineral alteration and self-sealing efficiency of a caprock for co 2 geological storage. Acta Geotech. 9, 87-100 (2014).
43. Patil, V. & Simmons, S. Utah forge: Evaluation of potential geochemical responses to injection in the forge geothermal reservoir. https://gdr.opneei.org/submissions/1247 (2019).
44. Shipton, Z. K. et al. Analysis of CO₂ leakage through ‘low-permeability’ faults from natural reservoirs in the Colorado Plateau, east-central Utah. Geol. Soc. London, Special Publ. 233, 43-58 (2004).
45. Patil, V. V. & McPherson, B. J. Identifying hydrogeochemical conditions for fault self-sealing in geological storage. Water Resour. Res. 56, e2018WR024436 (2020).
46. Lions, J. et al. Potential impacts of leakage from CO₂ geological storage on geochemical processes controlling fresh groundwater quality: a review. Int. J. Greenh. Gas Control. 22, 165-175 (2014).
47. Zheng, L., Apps, J. A., Zhang, Y., Xu, T. & Birkholzer, J. T. On mobilization of lead and arsenic in groundwater in response to CO₂ leakage from deep geological storage. Chem. geology 268, 281-297 (2009).
48. Xiao, T. et al. Potential chemical impacts of CO₂ leakage on underground source of drinking water assessed by quantitative risk analysis. Int. J. Greenh. Gas Control. 50, 305-316 (2016).
49. Biniek, K., Davies, R. & Henderson, K. Why commercial use could be the future of carbon capture. https://www.mckinsey.com/capabilities/sustanability/our-insights/why-commercial-use-could-be-the-future-of-carbon-capture (2018).
50. Carbon America to construct, own and operate the first two commercial carbon capture and sequestration projects in Colorado. https://www.businesswire.com/news/home/20220512005336/en/Carbon-America-to-Construct-Own-and-Operate-the-First-Two-Commercial-Carbon-Capture-and-Sequestration-Projects-in-Colorado (2022).
51. Sharma, A. & Gerig, G. Trajectories from distribution-valued functional curves: A unified Wasserstein framework. In Medical Image Computing and Computer Assisted Intervention—MICCAI 2020: 23rd International Conference, Lima, Peru, Oct. 4-8, 2020, Proceedings, Part VII 23, 343-353 (Springer, 2020).
52. Sharma, A. Temporal Modeling and Analysis of Distribution-Valued Functional Curves: Application to Diffusion Tensor Imaging. Ph.D. thesis, The University of Utah (2021).
53. The MathWorks Inc. MATLAB Version: 9.4.0.813654 (R2018a) (2018).

What is claimed:

1. A method for CO2 storage in an aquifer comprising using CO2 for well rehabilitation and preventive maintenance in improving well performance and efficiency and reducing the carbon footprint.

2. The method of claim 1, comprising sealing a water well and injecting liquid and or gaseous CO₂ into the water well and unsealing the water well to allow the CO₂ to be stored in the water well aquifer formation.

3. The method of claim 2 comprising modifying Aqua Freed or Aqua Gard technology to provide and enhance CO2 storage in the well aquifer.

4. The method of claim 3 increasing penetration of CO2 in the well aquifer by controlling and maintaining a constant CO2 injection pressure to prevent backflow and upward movement of CO2/water mixture with the well.

5. The process of claim 2 further comprising adjusting the CO2/water mixture to minimize expansion of CO2 in water allowing deeper CO2 aquifer penetration.

6. The process of claim 2 further comprising achieving additional CO2 storage by reducing a volume and rate of water flushing from the well after the completion of injecting CO2.

7. The process of claim 6 further comprising allowing well pressure to dissipate naturally within the well aquifer by not allowing CO2 to escape from the well into ambient atmosphere.
